(19) United States
(12) Patent Application Publication
(10) Pub. No.: US 2026/0339848 A1
(43) Pub. Date: Oct. 29, 2026

(54) VOLTAGE NOISE REDUCTION FOR MULTIBANK CENTRAL PROCESSING UNIT (CPU) CACHES

(71) Applicant: QUALCOMM Incorporated, San Diego, CA (US)

(72) Inventors: Darshan Kumar NANDANWAR, Bangalore (IN); Mrityunjay SINGH, Bangalore (IN); Ankit GOSALIA, Milpitas, CA (US); Ankur DEBNATH, San Diego, CA (US); Vishnu Priya BITRA, Guntur (IN)

(21) Appl. No.: 19/187,883

(22) Filed: Apr. 23, 2025

(51) Int. Cl. G06F 12/0842; G06F 12/0862

(52) U.S. Cl. CPC G06F 12/0842; G06F 12/0862

(57) ABSTRACT

A processor implemented method for voltage noise reduction for multibank central processing unit (CPU) caches includes monitoring concurrent activity of multiple banks of a multibank cache. The processor implemented method also includes generating, in response to the concurrent activity exceeding a predefined activity duration threshold, an idle period for one or more banks of the multibank cache.

### BACKGROUND

### Field

Aspects of the present disclosure relate to computing devices, and more specifically to voltage noise reduction for multibank central processing unit (CPU) caches.

### BACKGROUND

Mobile or portable computing devices include mobile phones, laptop, palmtop and tablet computers, portable digital assistants (PDAs), portable game consoles, and other portable electronic devices. Mobile computing devices are comprised of many electrical components that consume power and generate heat. The components (or compute devices) may include system-on-a-chip (SoC) devices, graphics processing unit (GPU) devices, neural processing unit (NPU) devices, digital signal processors (DSPs), and modems, among others.

Modern central processing unit (CPU) designs may use multiport multibank caches in order to improve cache latencies. Simultaneous accesses to the different banks in consecutive cycles may cause a high current draw for an extended period of time. If the high current demand persists for multiple cycles, voltage noise may be produced at a certain resonant frequency (e.g., matching the circuit's resonant frequency), causing a voltage emergency, such as memory faults at a lower voltage supply (VDD) profile, and disabled cache lines.

### SUMMARY

Various aspects of the present disclosure are directed to a multibank cache controller. The multibank cache controller includes a peak activity detector to monitor concurrent activity of multiple banks of a multibank cache. The multibank cache controller also includes a cache scheduler to generate, in response to the concurrent activity exceeding a predefined activity duration threshold, an idle period for one or more banks of the multibank cache.

In some aspects of the present disclosure, a processor-implemented method includes monitoring concurrent activity of multiple banks of a multibank cache. The processor-implemented method further includes generating, in response to the concurrent activity exceeding a predefined activity duration threshold, an idle period for one or more banks of the multibank cache.

Various aspects of the present disclosure are directed to an apparatus. The apparatus includes means for monitoring concurrent activity of multiple banks of a multibank cache. The apparatus further includes means for generating, in response to the concurrent activity exceeding a predefined activity duration threshold, an idle period for one or more banks of the multibank cache.

This has outlined, rather broadly, the features and technical advantages of the present disclosure in order that the detailed description that follows may be better understood. Additional features and advantages of the present disclosure will be described below. It should be appreciated by those skilled in the art that this present disclosure may be readily utilized as a basis for modifying or designing other structures for carrying out the same purposes of the present disclosure. It should also be realized by those skilled in the art that such equivalent constructions do not depart from the teachings of the present disclosure as set forth in the appended claims. The novel features, which are believed to be characteristic of the present disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following description taken in conjunction with the accompanying drawings.

FIG. 1 illustrates an example implementation of a host system-on-a-chip (SoC), including a multibank cache controller for managing voltage noise, in accordance with certain aspects of the present disclosure.

FIG. 2 is a block diagram illustrating an example multibank cache, in accordance with various aspects of the present disclosure.

FIG. 3A is a block diagram illustrating an example cache controller, in accordance with various aspects of the present disclosure.

FIG. 3B is a table illustrating an example activity queue of the multibank caches.

FIG. 3C is a timing diagram illustrating bubbles, in one or more of banks, generated by the bubble generator of FIG. 3A.

FIG. 4 is a flow diagram illustrating an example process for reducing voltage noise in multibank central processing unit (CPU) caches, in accordance with various aspects of the present disclosure.

FIG. 5 is a flow diagram illustrating an example process performed, for example, by a computing device such as a smartphone, in accordance with various aspects of the present disclosure.

FIG. 6 is a block diagram showing an exemplary wireless communications system in which a configuration of the present disclosure may be advantageously employed.

FIG. 7 is a block diagram illustrating a design workstation used for circuit, layout, and logic design of components, in accordance with various aspects of the present disclosure.

### DETAILED DESCRIPTION

The detailed description set forth below, in connection with the appended drawings, is intended as a description of various configurations and is not intended to represent the only configurations in which the concepts described may be practiced. The detailed description includes specific details for the purpose of providing a thorough understanding of the various concepts. It will be apparent, however, to those skilled in the art that these concepts may be practiced without these specific details. In some instances, well-known structures and components are shown in block diagram form in order to avoid obscuring such concepts.

As described, the use of the term “and/or” is intended to represent an “inclusive OR,” and the use of the term “or” is intended to represent an “exclusive OR.” As described, the term “exemplary” used throughout this description means “serving as an example, instance, or illustration,” and should not necessarily be construed as preferred or advantageous over other exemplary configurations. As described, the term “coupled” used throughout this description means “connected, whether directly or indirectly through intervening connections (e.g., a switch), electrical, mechanical, or otherwise,” and is not necessarily limited to physical connections. Additionally, the connections can be such that the objects are permanently connected or releasably connected. The connections can be through switches. As described, the term “proximate” used throughout this description means “adjacent, very near, next to, or close to.” As described, the term “on” used throughout this description means “directly on” in some configurations, and “indirectly on” in other configurations.

Modern central processing unit (CPU) designs may use multiport multibank caches in order to improve cache latencies. In a multibank cache, rather than organizing the cache as a single block of memory, the cache may be organized as a collection of independent banks to support concurrent access. In order to improve energy efficiency, modern CPUs use a lowered voltage supply (e.g., VDD). Lowering the VDD presents various challenges including voltage noise caused by abrupt, periodic (or resonant) fluctuations (e.g., noise) in the power demand.

In multibank caches, multiple sets of cache lines residing in multiple banks may be accessed simultaneously by the CPU. For instance, some of the banks may be accessed for demand of read or write from the load/store unit and some of the banks may be accessed by speculative prefetches or due to line-fills from higher level caches. Simultaneous accesses to the different banks in consecutive cycles may cause a high current draw for an extended period of time. If the high current demand persists for multiple cycles, voltage noise may be produced at a certain resonant frequency (e.g., matching the circuit's resonant frequency) causing a voltage emergency, such as memory faults at a lower VDD profile, and disabled cache lines.

To address these and other challenges, aspects of the present disclosure are directed to reducing voltage noise in multibank caches. In various aspects, a microarchitectural embedding may detect high activity regions in a cache controller and may implement no activity generator logic to initiate a bank bubble (e.g., period of inactivity). For instance, when high peak activity is detected for a configurable number of consecutive CPU cycles, voltage noise may be reduced and in some aspects., mitigated by introducing a bank bubble (also referred to as an idle cycle) in which there are no activities on some of the banks for configurable cycles. In doing so, the peak current activity to the multibank cache and voltage noise in CPU rail may be reduced, and in some aspects, eliminated.

Particular aspects of the subject matter described in this disclosure can be implemented to realize one or more of the following potential advantages. In some examples, the described techniques, such as detecting concurrent activity in multiple banks of a multibank cache and generating, in response to the concurrent activity exceeding a predefined activity duration threshold, an idle period in one or more banks of the multibank cache, may reduce cache latencies and energy efficiency in computing devices with a multibank CPU cache. Other advantages may include enabling operation of the CPUs with lower voltage guard bands and reduced overall power consumption with low impact on performance.

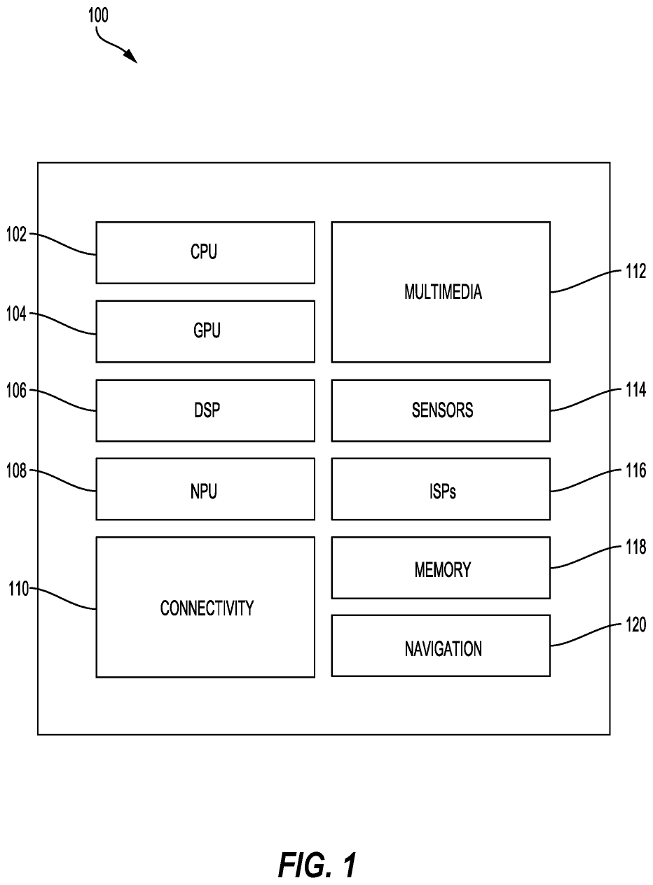

FIG. 1 illustrates an example implementation of a host system-on-a-chip (SoC) 100, which includes a multibank cache controller for managing voltage noise, in accordance with aspects of the present disclosure. The host SoC 100 includes processing blocks tailored to specific functions, such as a connectivity block 110. The connectivity block 110 may include fifth generation (5G) connectivity, fourth generation long term evolution (4G LTE) connectivity, Wi-Fi connectivity, universal serial bus (USB) connectivity, Bluetooth® connectivity, Secure Digital (SD) connectivity, and the like.

In this configuration, the host SoC 100 includes various processing units that support multi-threaded operation. For the configuration shown in FIG. 1, the host SoC 100 includes a multi-core central processing unit (CPU) 102, a graphics processor unit (GPU) 104, a digital signal processor (DSP) 106, and a neural processor unit (NPU) 108. The host SoC 100 may also include a sensor processor 114, image signal processors (ISPs) 116, a navigation module 120, which may include a global positioning system (GPS), and a memory 118. The multi-core CPU 102, the GPU 104, the DSP 106, the NPU 108, and the multi-media engine 112 support various functions such as video, audio, graphics, gaming, artificial networks, and the like. Each processor core of the multi-core CPU 102 may be a reduced instruction set computing (RISC) machine, an advanced RISC machine (ARM) , a microprocessor, or some other type of processor. The NPU 108 may be based on an ARM instruction set.

As described, aspects of the present disclosure are directed to reducing voltage noise in multibank caches. In various aspects, a microarchitectural embedding may detect high activity regions in a cache controller and may implement no activity generator logic to initiate a bank bubble (e.g., period of inactivity).

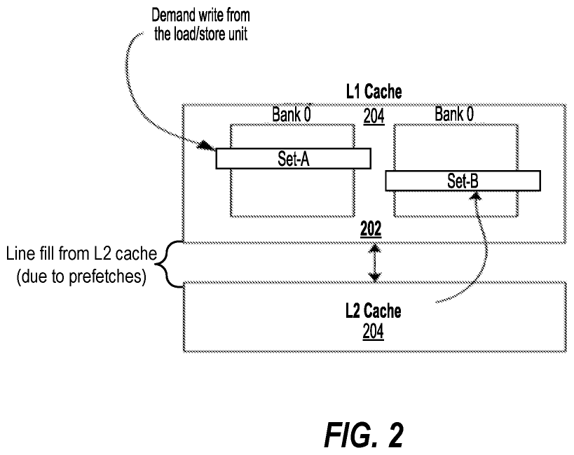

FIG. 2 is a block diagram illustrating an example multibank cache, in accordance with various aspects of the present disclosure. Referring to FIG. 2, the example multibank cache may include a bank 0 and a bank 1 in a level one (L 1) cache 202. Each bank may have a separate port for access by a CPU. Bank 0 may include a set of memory cells (set-A) and bank 1 may include a set of memory cells (set-B). In the example of FIG. 2, the set-A cache lines may be accessed by the CPU by way of a demand write from the load/store pipeline (e.g., from the load/store unit). Set-B cache lines may be concurrently accessed for a line fill for the level two (L2) cache 204, for example, for a prefetch operation. Prefetches to set-B within the same cycle as the accesses to set-A for an extended period of time (e.g., multiple cycles) may result in voltage noise.

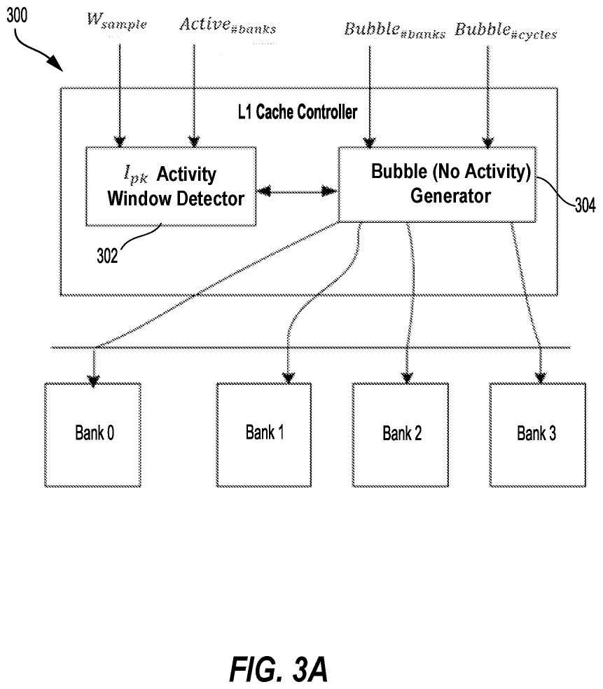

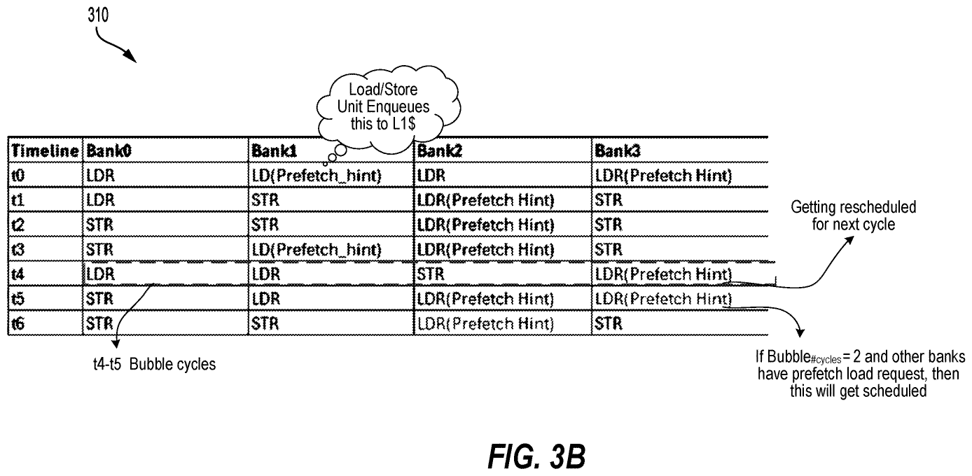

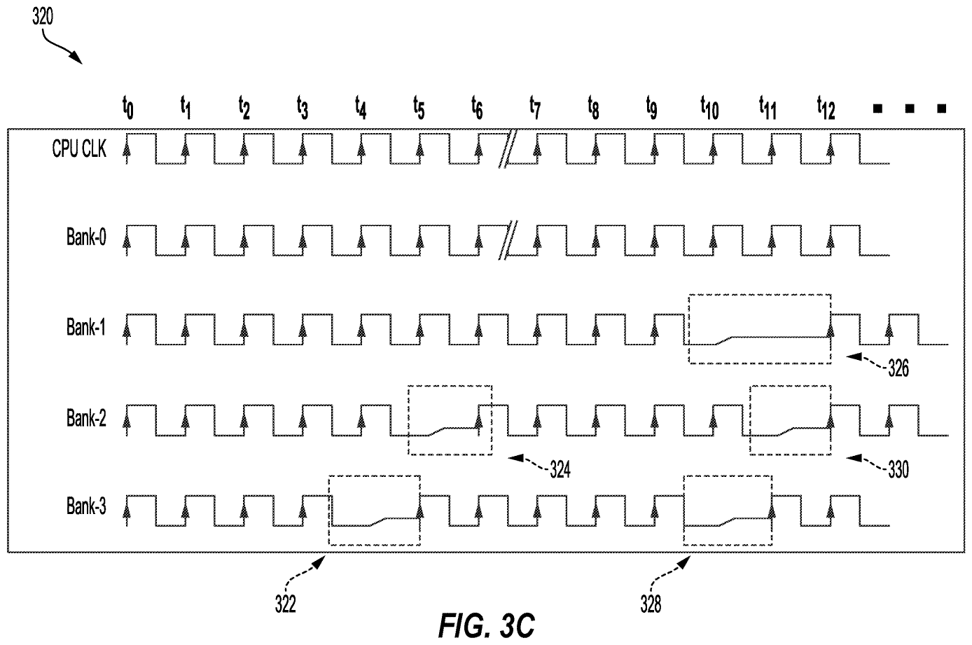

FIG. 3A is a block diagram illustrating an example cache controller 300 in accordance with various aspects of the present disclosure. Referring to FIG. 3A, the example multibank cache controller 300 may include a peak current (Iₚₖ) activity window detector 302 and a bubble (no activity) generator 304. The example multibank cache controller 300 may control cache banks 0-3. The Iₚₖ activity window detector 302 and the bubble generator 304 may each receive a set of one or more configurable parameters. For instance, the Iₚₖ activity window detector 302 may receive a window parameter (Wₛₐₘₚₗₑ) and an active bank identifier parameter (Active_{#banks}). The window parameter (Wₛₐₘₚₗₑ) may define an activity window. The activity window may indicate a number of consecutive cycles that configurable banks may be accessed concurrently. The active bank identifier parameter (Active_{#banks}) may indicate a number of banks to monitor for accesses in the activity window. The bubble generator 304 may receive a bubble identifier parameter (Bubble_{#banks}) and a bubble cycle parameter (Bubble_{#cycles}). The bubble identifier parameter (Bubble_{#banks}) may indicate a number of banks in which a bubble (idle period) may be introduced. The bubble cycle parameter (Bubble_{#cycles}) may indicate a bubble duration, such as a number of consecutive cycles in which a bubble (idle period) may be introduced in an identified bank.

Using the bubble identifier parameter (Bubble _{#banks}) and a bubble cycle parameter (Bubble_{#cycles}), the bubble generator 304 may manage the schedule for performed activity (e.g., load/store/prefetch) for the cache banks of the multibank cache. For instance, when the Iₚₖ activity window detector 302 indicates that the activity of the banks of the multibank cache has reached the predefined activity duration threshold (e.g., Wₛₐₘₚₗₑ), the bubble generator 304 may also reschedule activity directed to one or more of the cache banks (e.g., bank 0-3).

FIG. 3B is a table illustrating an example activity queue 310 of the multibank caches. Referring the FIG. 3B, the example activity queue 310 lists the load/store pipelines for cache banks 0-3 of the multibank cache during CPU clock cycles t0-t6. The Iₚₖ activity window detector 302 may monitor the CPU load/store pipelines issuing to the multibank cache controller 300 and next level (e.g., L2) cache demands in the same cycle within a defined activity window (e.g., Wₛₐₘₚₗₑ). For instance, the Iₚₖ activity window detector 302 may monitor for the CPU load/store pipelines issuing to the multibank cache controller 300 and next level cache demands in the same cycle during the activity window of four cycles.

If the Iₚₖ activity window detector 302 determines concurrent activity in the active banks exceeds the defined window, the Iₚₖ activity window detector 302 may trigger the bubble generator 304 to generate a bubble (idle period) in one or more cache banks according to the defined bubble duration. During the defined activity window (e.g., t0-t3), each of the cache banks (e.g., bank 0-bank 3) are being accessed by a load (LDR)/store (STR) pipeline or accessed by a next level cache for a prefetch request. In some aspects, the defined activity window may correspond to a duration for the defined number of banks monitored (Active _{#banks}) at which concurrent activity may reach the voltage noise associated with the cache banks (e.g., banks 0-3) to reach the resonant frequency. Accordingly, the Iₚₖ activity window detector 302 may trigger the bubble generator 304 to generate a bubble (idle period) in the next time period. That is, the activity of banks 0-2 may be permitted, and the bubble generator 304 generates a bubble for bank 3. The activity of bank 3 (e.g., a prefetch load request) may be rescheduled for a next cycle (e.g., t5).

Because the bubble cycle parameter is set to 2 and other banks (bank 0, bank 1, and bank 3) have prefetch load requests in cycle t5, the bubble generator may generate a bubble for bank 2 and the prefetch load request for bank 2 may be rescheduled for the next cycle (e.g., t6).

FIG. 3C is a timing diagram 320 illustrating the bubbles generated in one or more of banks 0-3 by the bubble generator 304. As shown in FIG. 3C, at cycle t4 of CPU clock (CLK), a bubble (idle period) 322 is generated in bank 3. Similarly, at cycle t5 of the CPU CLK, a bubble (idle period) 324 is generated in bank 2. Although, the duration of bubbles 322 and 324 are each one clock cycle, the present disclosure is not so limiting. Rather, as indicated, the bubble duration may be configured for longer periods. For instance, a bubble 326 in bank 1 has a duration of two cycles. Furthermore, the bubble generator 304 may also generate a bubble on multiple banks of a clock cycle. For instance, bubbles 328 and 330 may overlap bubble 326, for further reduction of voltage noise.

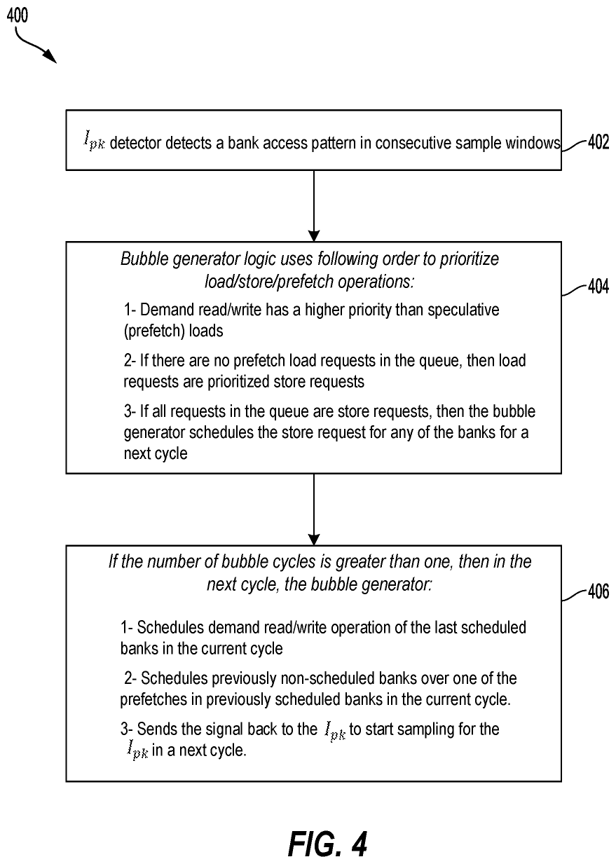

FIG. 4 is a flow diagram illustrating an example process 400 for reducing voltage noise in multibank CPU caches, in accordance with various aspects of the present disclosure. Referring to FIG. 4, at block 402, a peak withstand current (Iₚₖ) detector detects a bank access pattern in consecutive sample windows. The Iₚₖ detector may determine if the configurable (defined) number of banks are accessed for the defined number of sample cycles (Wₛₐₘₚₗₑ). If the Iₚₖ detector determines the number has been reached for the defined samples, the Iₚₖ detector may assert a signal to trigger the bubble generator to generate a bubble (idle period).

At block 404, the bubble generator may implement a priority for load, store and prefetch operations. For example, in a first priority level, demand read/write may have a higher priority than speculative (e.g., prefetch) load requests. In a second priority level, if there are no prefetch load requests in the queue, load requests may be prioritized over store requests. In a third priority level, if all requests in the queue are store requests, then the bubble generator may schedule the store request for any of the banks in which a bubble was asserted for a next clock cycle.

At block 406, the bubble generator may generate a bubble and schedule cache activity. For instance, if the number of bubble cycles is greater than one, then in the next cycle, the bubble generator may first schedule a demand read/write operation of the last scheduled banks in the current cycle. Then, the bubble generator may schedule previously non-scheduled banks over one of the prefetches in previously scheduled banks if the last scheduled banks have one or more prefetch requests. Thereafter, the bubble generator may send the signal back to the Iₚₖ activity window detector to start sampling for the peak current Iₚₖ in a next cycle.

According to aspects of the present disclosure, a computing device such as a smartphone or other mobile device includes means for monitoring concurrent activity of multiple banks of a multibank cache. The computing device may also include means for generating, in response to the concurrent activity exceeding a predefined activity duration threshold, an idle period for one or more banks of the multibank cache. In one configuration, the monitoring means may be the peak current (Iₚₖ) activity window detector 302 or the multibank cache controller 300 and the generating means may be the bubble generator 304 or the multibank cache controller 300 as shown in FIG. 3A, for example. In other aspects, the aforementioned means may be any structure or any material configured to perform the functions recited by the aforementioned means.

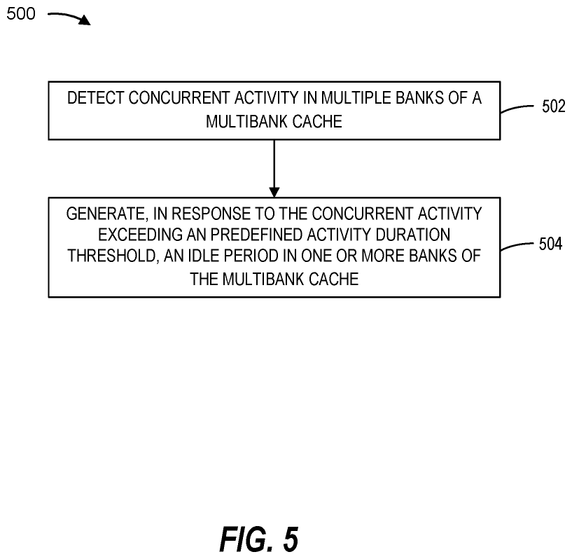

FIG. 5 is a flow diagram illustrating an example process 500 performed, for example, by a computing device such as a smartphone or other mobile computing device, in accordance with various aspects of the present disclosure. The example process 500 is an example of managing voltage noise in multibank CPU caches.

As shown in FIG. 5, at block 502, the process 500 monitors concurrent activity of multiple banks of a multibank cache. For example, as described with reference to FIG. 3B, The Iₚₖ activity window detector 302 may monitor the CPU load/store pipelines issuing to the multibank cache controller 300 and next level (e.g., L2) cache demands in the same cycle within a defined activity window (e.g., Wₛₐₘₚₗₑ). For instance, the Iₚₖ activity window detector 302 may monitor for the CPU load/store pipelines issuing to the multibank cache controller 300 and next level cache demands in the same cycle during the activity window of four cycles.

At block 504, the process 500 generates, in response to the concurrent activity exceeding a predefined activity duration threshold, an idle period in one or more banks. For instance, as described with reference to FIG. 3B, if the Iₚₖ activity window detector 302 determines concurrent activity in the active banks exceeds the defined window, the Iₚₖ activity window detector 302 may trigger the bubble generator 304 to generate a bubble (idle period) in one or more cache banks according to the defined bubble duration.

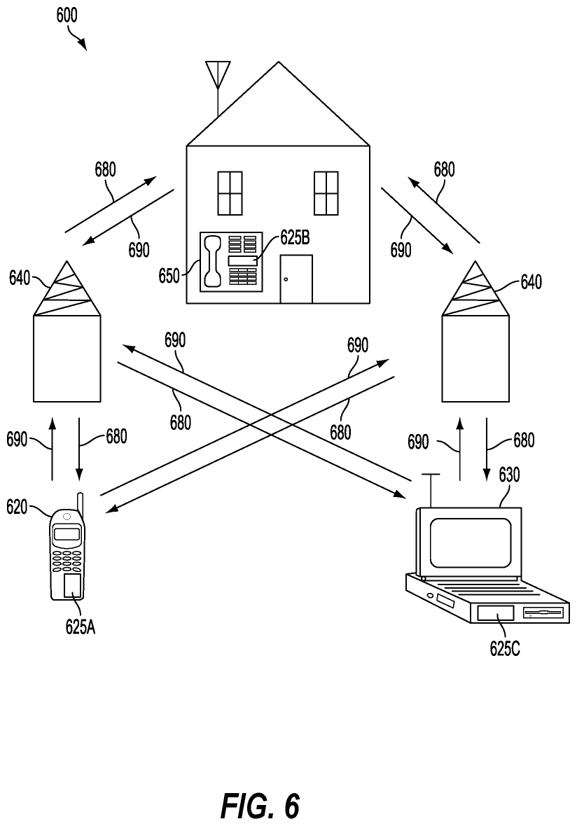

FIG. 6 is a block diagram showing an exemplary wireless communications system 600, in which an aspect of the present disclosure may be advantageously employed. For purposes of illustration, FIG. 6 shows three remote units 620, 630, and 650, and two base stations 640. It will be recognized that wireless communications systems may have many more remote units and base stations. Remote units 620, 630, and 650 include integrated circuit (IC) devices 625A, 625B, and 625C that include the disclosed multibank cache controller 300. It will be recognized that other devices may also include the disclosed multibank cache controller 300, such as the base stations, switching devices, and network equipment. FIG. 6 shows forward link signals 680 from the base stations 640 to the remote units 620, 630, and 650, and reverse link signals 690 from the remote units 620, 630, and 650 to the base stations 640.

In FIG. 6, remote unit 620 is shown as a mobile telephone, remote unit 630 is shown as a portable computer, and remote unit 650 is shown as a fixed location remote unit in a wireless local loop system. For example, the remote units may be a mobile phone, a hand-held personal communication systems (PCS) unit, a portable data unit, such as a personal data assistant, a GPS enabled device, a navigation device, a set top box, a music player, a video player, an entertainment unit, a fixed location data unit, such as meter reading equipment, or other device that stores or retrieves data or computer instructions, or combinations thereof. Although FIG. 6 illustrates remote units according to the aspects of the present disclosure, the disclosure is not limited to these exemplary illustrated units. Aspects of the present disclosure may be suitably employed in many devices, which include the disclosed multibank cache controller 300.

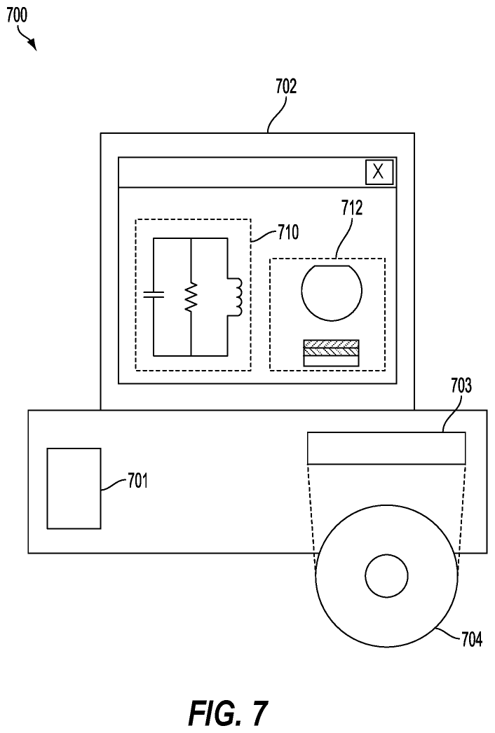

FIG. 7 is a block diagram illustrating a design workstation 700 used for circuit, layout, and logic design of a semiconductor component, such as the multibank cache controller 300 disclosed above. The design workstation 700 includes a hard disk 601 containing operating system software, support files, and design software such as Cadence or OrCAD. The design workstation 700 also includes a display 702 to facilitate design of a circuit 710 or a semiconductor component 712, such as the multibank cache controller 300. A storage medium 704 is provided for tangibly storing the design of the circuit 710 or the semiconductor component 712 (e.g., the PLD). The design of the circuit 710 or the semiconductor component 712 may be stored on the storage medium 704 in a file format such as GDSII or GERBER. The storage medium 704 may be a CD-ROM, DVD, hard disk, flash memory, or other appropriate device. Furthermore, the design workstation 700 includes a drive apparatus 703 for accepting input from or writing output to the storage medium 704.

Data recorded on the storage medium 704 may specify logic circuit configurations, pattern data for photolithography masks, or mask pattern data for serial write tools such as electron beam lithography. The data may further include logic verification data such as timing diagrams or net circuits associated with logic simulations. Providing data on the storage medium 704 facilitates the design of the circuit 710 or the semiconductor component 712 by decreasing the number of processes for designing semiconductor wafers.

### Example Aspects

Aspect 1: A multibank cache controller, comprising: a peak activity detector to monitor concurrent activity of multiple banks of a multibank cache; and a cache scheduler to generate, in response to the concurrent activity exceeding a predefined activity duration threshold, an idle period for one or more banks of the multibank cache.

Aspect 2: The multibank cache controller of Aspect 1, wherein the peak activity detector detects when the concurrent activity of the multiple banks exceeds the predefined activity duration threshold.

Aspect 3: The multibank cache controller of Aspect 1 or 2, wherein the cache scheduler is configured to reschedule activity directed to the one or more banks in which the idle period is generated.

Aspect 4: The multibank cache controller of any preceding Aspect, wherein the cache scheduler reschedules the activity directed to the one or more banks in which the idle period is generated for a later clock cycle based on a priority associated with the activity.

Aspect 5: The multibank cache controller of any preceding Aspect, wherein the cache scheduler reschedules read/write demand activity with a higher priority than prefetch activity.

Aspect 6: The multibank cache controller of any preceding Aspect, wherein the cache scheduler reschedules load requests with a higher priority than store requests if there is no prefetch activity.

Aspect 7: The multibank cache controller of any preceding Aspect, wherein a duration of the idle period for the one or more banks and the predefined activity duration threshold are configurable.

Aspect 8: A processor-implemented method, performed by one or more processors, the processor implemented method comprising: monitoring concurrent activity of multiple banks of a multibank cache; and generating, in response to the concurrent activity exceeding a predefined activity duration threshold, an idle period for one or more banks of the multibank cache.

Aspect 9: The processor-implemented method of Aspect 8, further comprising detecting, by a peak activity detector, when the concurrent activity of the multiple banks exceeds the predefined activity duration threshold.

Aspect 10: The processor-implemented method of Aspect 8 or 9, further comprising rescheduling activity directed to the one or more banks in which the idle period is generated.

Aspect 11: The processor-implemented method of any of Aspects 8-10, further comprising rescheduling the activity directed to the one or more banks in which the idle period is generated for a later clock cycle based on a priority associated with the activity.

Aspect 12: The processor-implemented method of any of Aspects 8-11, wherein read/write demand activity is rescheduled with a higher priority than prefetch activity.

Aspect 13: The processor-implemented method of any of Aspects 8-12, wherein load requests are rescheduled with a higher priority than store requests if there is no prefetch activity.

Aspect 14: The processor-implemented method of any of Aspects 8-13, wherein a duration of the idle period for the one or more banks and the predefined activity duration threshold are configurable.

Aspect 15: An apparatus, comprising: means for monitoring concurrent activity of multiple banks of a multibank cache; and means for generating, in response to the concurrent activity exceeding a predefined activity duration threshold, an idle period for one or more banks of the multibank cache.

Aspect 16: The apparatus of Aspect 15, further comprising means for detecting, by a peak activity detector, when the concurrent activity of the multiple banks exceeds the predefined activity duration threshold.

Aspect 17: The apparatus of Aspect 15 or 16, further comprising means for rescheduling activity directed to the one or more banks in which the idle period is generated.

Aspect 18: The apparatus of any of Aspects 15-17, further comprising means for rescheduling the activity directed to the one or more banks in which the idle period is generated for a later clock cycle based on a priority associated with the activity.

Aspect 19: The apparatus of any of Aspects 15-18, wherein read/write demand activity is rescheduled with a higher priority than prefetch activity.

Aspect 20: The apparatus of any of Aspects 15-19, wherein load requests are rescheduled with a higher priority than store requests if there is no prefetch activity.

For a firmware and/or software implementation, the methodologies may be implemented with modules (e.g., procedures, functions, and so on) that perform the functions described. A machine-readable medium tangibly embodying instructions may be used in implementing the methodologies described. For example, software codes may be stored in a memory and executed by a processor unit. Memory may be implemented within the processor unit or external to the processor unit. As used, the term “memory” refers to types of long term, short term, volatile, nonvolatile, or other memory and is not limited to a particular type of memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be an available medium that can be accessed by a computer. By way of example, and not limitation, such computer-readable media can include random access memory (RAM) , read-only memory (ROM) , electrically erasable read-only memory (EEPROM) , compact disc read-only memory (CD-ROM) or other optical disk storage, magnetic disk storage or other magnetic storage devices, or other medium that can be used to store desired program code in the form of instructions or data structures and that can be accessed by a computer. Disk and disc, as used, include compact disc (CD), laser disc, optical disc, digital versatile disc (DVD), floppy disk, and Blu-ray® disc, where disks usually reproduce data magnetically, while discs reproduce data optically with lasers. Combinations of the above should also be included within the scope of computer-readable media.

In addition to storage on computer-readable medium, instructions and/or data may be provided as signals on transmission media included in a communications apparatus. For example, a communications apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions, and alterations can be made without departing from the technology of the disclosure as defined by the appended claims. For example, relational terms, such as “above” and “below” are used with respect to a substrate or electronic device. Of course, if the substrate or electronic device is inverted, above becomes below, and vice versa. Additionally, if oriented sideways, above and below may refer to sides of a substrate or electronic device. Moreover, the scope of the present disclosure is not intended to be limited to the particular configurations of the process, machine, manufacture, composition of matter, means, methods, and steps described in the specification. As one of ordinary skill in the art will readily appreciate from the present disclosure, processes, machines, manufacture, compositions of matter, means, methods, or steps, presently existing or later to be developed that perform substantially the same function or achieve substantially the same result as the corresponding configurations described may be utilized according to the present disclosure. Accordingly, the appended claims are intended to include within their scope such processes, machines, manufacture, compositions of matter, means, methods, or steps.

Those of skill would further appreciate that the various illustrative logical blocks, modules, circuits, and algorithm steps described in connection with the present disclosure may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure may be implemented or performed with a general purpose processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in RAM, flash memory, ROM, erasable programmable read-only memory (EPROM) , EEPROM, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the present disclosure is provided to enable any person skilled in the art to make or use the present disclosure. Various modifications to the disclosure will be readily apparent to those skilled in the art, and the generic principles defined may be applied to other variations without departing from the spirit or scope of the disclosure. Thus, the present disclosure is not intended to be limited to the examples and designs described, but is to be accorded the widest scope consistent with the principles and novel features disclosed.

1. A multibank cache controller, comprising:
a peak activity detector to monitor concurrent activity of multiple banks of a multibank cache during an activity window comprising a first number of consecutive cycles in which the multiple banks of the multibank cache are accessed concurrently; and
a cache scheduler to generate, in response to the concurrent activity exceeding a predefined activity duration threshold corresponding to the activity window, an idle period for one or more banks of the multibank cache, the idle period comprising a second number of consecutive cycles in which activity is absent on the one or more banks.

2. The multibank cache controller of claim 1, wherein the peak activity detector detects when the concurrent activity of the multiple banks exceeds the predefined activity duration threshold.

3. The multibank cache controller of claim 1, wherein the cache scheduler is configured to reschedule activity directed to the one or more banks in which the idle period is generated.

4. The multibank cache controller of claim 3, wherein the cache scheduler reschedules the activity directed to the one or more banks in which the idle period is generated for a later clock cycle based on a priority associated with the activity.

5. The multibank cache controller of claim 4, wherein the cache scheduler reschedules read/write demand activity with a higher priority than prefetch activity.

6. The multibank cache controller of claim 4, wherein the cache scheduler reschedules load requests with a higher priority than store requests if there is no prefetch activity.

7. The multibank cache controller of claim 1, wherein a duration of the idle period for the one or more banks and the predefined activity duration threshold are configurable.

8. A processor-implemented method, performed by one or more processors, the processor implemented method comprising:
monitoring concurrent activity of multiple banks of a multibank cache during an activity window comprising a first number of consecutive cycles in which the multiple banks of the multibank cache are accessed concurrently; and
generating, in response to the concurrent activity exceeding a predefined activity duration threshold corresponding to the activity window, an idle period for one or more banks of the multibank cache, the idle period comprising a second number of consecutive cycles in which activity is absent on the one or more banks.

9. The processor-implemented method of claim 8, further comprising detecting, by a peak activity detector, when the concurrent activity of the multiple banks exceeds the predefined activity duration threshold.

10. The processor-implemented method of claim 8, further comprising rescheduling activity directed to the one or more banks in which the idle period is generated.

11. The processor-implemented method of claim 10, further comprising rescheduling the activity directed to the one or more banks in which the idle period is generated for a later clock cycle based on a priority associated with the activity.

12. The processor-implemented method of claim 11, wherein read/write demand activity is rescheduled with a higher priority than prefetch activity.

13. The processor-implemented method of claim 11, wherein load requests are rescheduled with a higher priority than store requests if there is no prefetch activity.

14. The processor-implemented method of claim 8, wherein a duration of the idle period for the one or more banks and the predefined activity duration threshold are configurable.

15. An apparatus, comprising:
means for monitoring concurrent activity of multiple banks of a multibank cache during an activity window comprising a first number of consecutive cycles in which the multiple banks of the multibank cache are accessed concurrently; and
means for generating, in response to the concurrent activity exceeding a predefined activity duration threshold corresponding to the activity window, an idle period for one or more banks of the multibank cache, the idle period comprising a second number of consecutive cycles in which activity is absent on the one or more banks.

16. The apparatus of claim 15, further comprising means for detecting, by a peak activity detector, when the concurrent activity of the multiple banks exceeds the predefined activity duration threshold.

17. The apparatus of claim 15, further comprising means for rescheduling activity directed to the one or more banks in which the idle period is generated.

18. The apparatus of claim 17, further comprising means for rescheduling the activity directed to the one or more banks in which the idle period is generated for a later clock cycle based on a priority associated with the activity.

19. The apparatus of claim 18, wherein read/write demand activity is rescheduled with a higher priority than prefetch activity.

20. The apparatus of claim 18, wherein load requests are rescheduled with a higher priority than store requests if there is no prefetch activity.
